(19) United States
(12) Patent Application Publication
(10) Pub. No.: US 2007/0236723 A1
(43) Pub. Date: Oct. 11, 2007

(54) DETERMINING A RESTART POINT OR REPRINT RANGE FOR REPRINTING A PRINT JOB

(76) Inventors: Joseph P. Gaertner, Lafayette, CO (US); Janeen E. Jahn, Lafayette, CO (US); Kumar V. Kadiyala, Boulder, CO (US); Linda S. Liebelt, Boulder, CO (US); Dwight R. Palmer, Longmont, CO (US); Jeri L. Sampson, Boulder, CO (US); Marquis G. Waller, Louisville, CO (US); Matthew M. Walli, Longmont, CO (US)

Correspondence Address: DUFT BORNSEN & FISHMAN, LLP, 1526 SPRUCE STREET, SUITE 302, BOULDER, CO, 80302, US

(21) Appl. No.: 11/279,057

(22) Filed: Apr. 7, 2006

(51) Int. Cl. G06F 3/12; G06K 15/00; G06F 17/00

(52) U.S. Cl. 358/1.15; 358/1.14; 715/525

(57) ABSTRACT

Methods, systems, and computer program products are disclosed for determining the restart point for reprinting of a print job, such as for continuous forms printers. A method of the invention includes a step of processing the print job to identify logical pages in the print job. Another step includes mapping the logical pages to sheets on which the logical pages will be subsequently printed to generate a page-to-sheet data structure. If there is a request to reprint the print job, then the method includes another step of identifying a logical page from which to initiate reprinting of the print job based on input from all operator. Another step includes identifying a sheet corresponding with the logical page based on the page-to-sheet data structure to allow for reprinting of the print job from the identified sheet. When the sheet is identified, reprinting may begin from the identified sheet.

### BACKGROUND OF THE INVENTION

1. Field of the Invention

The invention relates to the field of printing and, in particular, to determining a restart point for reprinting a print job if one or more printed pages are defective or damaged, or also to determining a reprint range of pages for preprinting a print job.

2. Statement of the Problem

Production printing and mass printing are prone to errors like any mechanical manufacturing process. During the printing of a print job, one or more of the printed pages may be damaged or otherwise rendered defective. For instance, a high-speed continuous forms printer may encounter a paper jam while printing the print job. Post-processing equipment attached to the continuous forms printer, such as cutters, inserters, sorters, or stackers can damage printed pages. The continuous forms printer may print one or more pages lighter than is desired. As a consequence, operators may need to reprint defective pages that encountered errors somewhere in the workflow.

There are typically two scenarios for reprinting defective printed pages of a print job. One scenario is where the print job that encountered the error is still active on the printer and can be backed up to the point of the error. Another scenario is where the error is not discovered until the print job has left the printer. In both scenarios, it is desirable to reprint only those pages of the print job that are defective.

Many times the defective printed pages are identified by the operator some time after the pages were printed. Thus, it is presently a problem to be able to determine where to restart the print job in order to reprint the defective printed pages. The operator needs to either input the sheet number into the print server or print controller from which to restart the print job, or needs to specify how many sheets to back up to resume printing from the restart point. The operator generally has to guess as to the sheet number of the restart point, and then use trial and error to determine the correct restart point which often wastes paper and time.

The sheet number corresponds with a given printed page and may be influenced by several factors that make it difficult for the operator to guess the correct restart point. For example, if the printer is performing duplex N-up printing, then the operator has to take that into account when calculating the sheet number for the correct restart point. Also, duplex printing can be turned on and off for individual sheets within the print job further complicating the counts. Users can also request that some (and not all) pages are printed in multiple copies further changing the sheet count for the whole job.

There are mechanisms in some continuous forms printers that allow for automatic reprinting in the event of a paper jam. The printer can determine when the paper jam occurred, and can calculate how many sheets to back up to reprint pages that may have been damaged by the paper jam. Unfortunately, there are many instances where the printer cannot detect the error, and the operator is the one that detects the error. For instance, if a post-processing system damages multiple printed pages, then the operator is the one who will detect the error. The operator will thus have the responsibility of determining the restart point for reprinting as described above.

### SUMMARY OF THE SOLUTION

The present invention solves the above and other related problems by generating a page-to-sheet mapping of a print job and using the page-to-sheet mapping to determine the correct sheet from which to begin reprinting of the print job. Assume for instance that an operator detects one or more defective printed pages. The operator may indicate the defective printed pages, such as by page number, to systems described herein. The systems then use the page-to-sheet mapping to identify the sheet that corresponds with the defective printed pages. Reprinting may then begin from the sheet identified from the page-to-sheet mapping. The operator advantageously does not need to guess where the restart point should be and go through the trial and error process that presently burdens the operator.

One embodiment of the invention comprises a method of determining the restart point for reprinting of a print job. One step of the method includes processing the print job to identify logical pages in the print job. Another step of the method includes mapping the logical pages to sheets on which the logical pages will be subsequently printed to generate a page-to-sheet data structure. If there is a request to reprint the print job, then the method includes another step of identifying a logical page from which to initiate reprinting of the print job based on input from an operator. Another step of the method includes identifying a sheet corresponding with the logical page based on the page-to-sheet data structure to allow for reprinting of the print job from the identified sheet. When the sheet is identified from which to initiate reprinting, reprinting may begin from the identified sheet.

Another embodiment comprises a system adapted to determine the restart point for reprinting of a print job. The system of this embodiment includes a mapping system adapted to process the print job to identify logical pages in the print job and map the logical pages to sheets on which the logical pages will subsequently be printed to generate a page-to-sheet data structure. The system further includes a reprint system adapted to identify a logical page from which to initiate reprinting of the print job based on input from an operator and identify a sheet corresponding with the logical page based on the page-to-sheet data structure to allow for reprinting of the print job from the identified sheet.

Another embodiment of the invention comprises a computer program product comprising a computer useable medium including a computer readable program. The computer readable program when executed on a computer causes the computer to process the print job to identify logical pages in a print job, and map the logical pages to sheets on which the logical pages will be subsequently printed to generate a page-to-sheet data structure. If there is a request to reprint the print job, then the computer readable program further causes the computer to identify a logical page from which to initiate reprinting of the print job based on input from an operator, and identify a sheet corresponding with the logical page based on the page-to-sheet data structure to allow for reprinting of the print job from the identified sheet.

The invention may include other exemplary embodiments described below.

### DESCRIPTION OF THE DRAWINGS

FIG. 1 illustrates an enhanced printing environment in an exemplary embodiment of the invention.

FIG. 2 illustrates a system adapted to determine the restart point for restarting a print job in an exemplary embodiment of the invention.

FIG. 3 is a flow chart illustrating a method of determining the restart point for reprinting the print job in an exemplary embodiment of the invention.

FIG. 4 is a flow chart illustrating a method of allowing the operator to enter a printed page identifier in an exemplary embodiment of the invention.

FIG. 5 is a flow chart illustrating a method of allowing the operator to search for the correct logical page in an exemplary embodiment of the invention.

FIG. 6 illustrates a computer system in an exemplary embodiment of the invention.

### DETAILED DESCRIPTION OF THE INVENTION

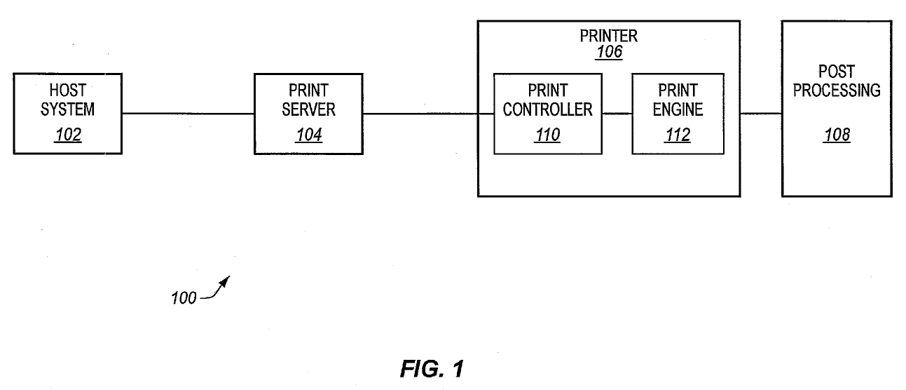

FIGS. 1-6 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 illustrates an enhanced printing environment 100 in an exemplary embodiment of the invention that allows for intelligently determining the restart point of a print job according to features and aspects herein. Printing environment 100 includes a host system 102, a print server 104, a printer 106, and a post-processing system 108. Host system 102 is adapted to transmit a print job to print server 104. The print job in raw form is generally encoded in the form of a page description language, such as PostScript, Hewlett-Packard PCL, Advanced Function Presentation Data Stream (AFPDS), etc. Print server 104 is adapted to manage printer 106 and possibly other printers not shown, such as to queue the print job for printer 106.

Printer 106 comprises a continuous forms printer in this embodiment, but may comprise a cut sheet printer in other embodiments. Printer 106 includes a printer controller 110 that is adapted to interpret the received raw print job to generate rasterized images of pages represented by the raw print job. Each rasterized page image generally comprises a 2-dimensional array of picture elements (“pixels”) that represent a corresponding formatted page of the raw print job. The process of interpreting the raw print job to generate corresponding rasterized page images is typically referred to as “ripping” and the sequences of rasterized pages may be referred to as a “ripped print job” or “rasterized print job”.

Print controller 110 may then apply the ripped print job to a print engine 112 (sometimes also referred to as an “imaging engine” or as a “marking engine”). Print engine 112 then interacts with an imaging process to mark the form (e.g., printable medium) with the ripped pages provided by print controller 110. Post-processing system 108 may comprise a trimmer, a cutter, a sorter, a stacker, or another type of device that performs operations on the sheets after being printed on by the imaging process.

Printing environment 100 may include other systems not shown in FIG. 1 for the sake of brevity. For instance, a transform system may be used to convert incoming print jobs from one encoding to another encoding, possibly a proprietary encoding used in the printing system. For instance, the transform system may convert a print job from PCL to AFPDS. In another example, there may be an external interpreter that rips print jobs outside of the print controller 110.

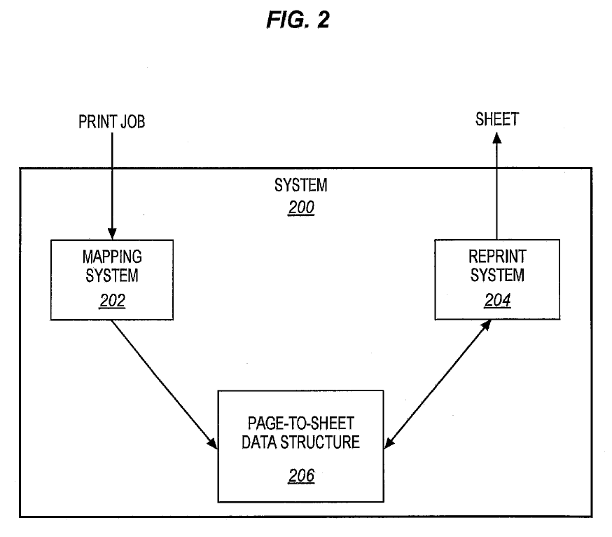

FIG. 2 illustrates a system 200 adapted to determine the restart point for restarting a print job in an exemplary embodiment of the invention. System 200 includes a mapping system 202 and a reprint system 204. Mapping system 202 is adapted to generate a page-to-sheet data structure 206. System 200 may be implemented in many desired locations in printing environment 100 of FIG. 1. For instance, system 200 may be located in print server 104, in print controller 110, or in another system. System 200 may also be distributed among multiple systems in printing environment 100.

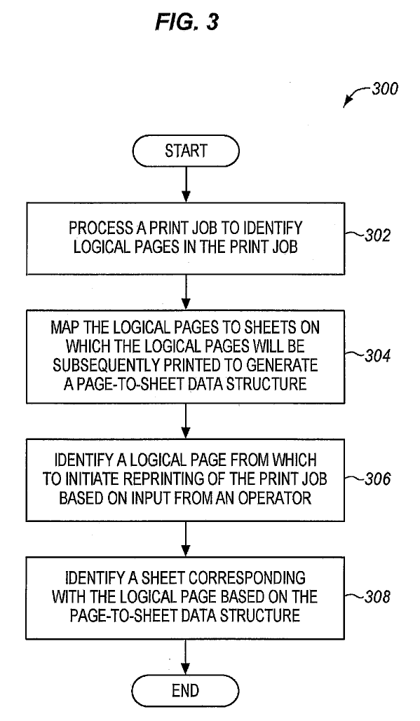

In FIG. 1, assume that printer 106 is printing or has printed a print job from host 102. Also assume that an operator detects an error and determines that a reprint of one or more printed pages is needed. FIG. 3 is a flow chart illustrating a method 300 of determining the restart point for reprinting the print job in an exemplary embodiment of the invention. Method 300 describes some basic steps of the method, but other steps may also be performed as needed or desired. Method 300 is illustrated as being performed by system 200 provided in FIG. 2.

In step 302, mapping system 202 processes the print job to identify logical pages in the print job. A logical page comprises the data (metadata and content) in the print job that represents a physical page that will be subsequently printed. Mapping system 202 may process the raw print job to identify the logical pages in the raw print job, or may process the ripped print job to identify the logical pages in the ripped print job. Logical pages may be represented in the raw data stream, or may be represented in the ripped data stream. Mapping system 202 may process the print job as the print job is being transmitted to printer 106, or may process the print job before or after the print job has been printed.

Mapping system 202 may identify the logical pages in a variety of ways. For instance, mapping system 202 may process the print job to identify page breaks between the logical pages in the print job, and identify the logical pages based on the identified page breaks. The page breaks may comprise the beginning of a page or the end of a page. There may be tags or some other indicator in the print job that represent the page breaks.

In step 304, mapping system 202 maps the logical pages to sheets on which the logical pages will be subsequently printed to generate page-to-sheet data structure 206. The page-to-sheet data structure 206 may comprise a database, a table, a list, or any other type of data structure. How the logical pages are laid out on a sheet depends on the form definition (also referred to as the layout or imposition) defined for the print job. The form definition herein also includes any other print parameters needed to define the layout of the logical pages on the sheets. The form definition may be simplex, duplex, N-up, N-up duplex, etc. Mapping system 202 is able to identify the form definition for the print job, and determine which logical pages will be printed on which sheets based on the form definition. Mapping system 202 is thus able to map the logical pages to the sheets in page-to-sheet data structure 206 based on the form definition. For instance, the mapping may have logical pages 1-4 corresponding with sheet 1 (front side) and logical pages 5-8 corresponding with sheet 1 (back side) for a 4-up duplex form definition. The mapping may have logical pages 40-41 corresponding with sheet 10 (front side) and logical pages 42-43 corresponding with sheet 10 (back side) for a 2-up duplex form definition. Mapping system 202 may also be able to identify the page copies for the logical pages, such as if one logical page is to be printed more than once. This further allows mapping system 202 to map the logical pages to the sheets.

Mapping system 202 is also able to handle the situation where the user of host system 102 requests a constant form. One example of a constant form is when the user requests that the back side of a sheet be left blank. Another example is when the user requests that the back side of a sheet be printed with predefined constant data (mimicking a preprinted form) that is not included in the logical page data. Mapping system 202 is able to identify the pages of a constant form and provide the correct sheet mapping.

As one example of how to implement mapping system 202, assume that a processor is executing a program such as AFP Conversion and Indexing Facility (ACIF) or a similar program. ACIF may be used to insert index information in a print job. The index information can include tags that identify a page by its contents, such as an account number. ACIF can also include tags that correspond with page breaks. Because ACIF has access to all of the formatting information that will eventually be used to print the job, it may also be used to produce sheet information. Function calls may be added to ACIF, such as Begin Page and End Page Exits, that are called as ACIF is processing each page start or page end indication in the print job data stream. When a function call is executed at a page break, the function call identifies the logical page corresponding with the page break. The function call also identifies the sheet that the logical page will subsequently be printed on based on the form definition for the print job, and maps the logical page to the sheet. The function calls being run at each page break generate a data structure, such as the page-to-sheet data structure 206, that maps pages to sheets for the print job.

If the operator determines that a reprint is needed for one or more printed pages, then reprint system 204 operates as follows. In step 306, reprint system 204 identifies a logical page from which to initiate reprinting of the print job based on input from the operator. The input from the operator may take on many forms. In one example, the operator may input a logical page number or another identifier for the logical page for which reprinting should begin. In another example, the operator may input a page number from the printed page, and reprint system 204 is able to determine the correct logical page based on the printed page identifier. In another example, reprint system 204 may provide a search mechanism that allows the operator to search for keywords or phases in the print job to locate the correct logical page.

In step 308, reprint system 204 identifies a sheet corresponding with the logical page based on the page-to-sheet data structure 206 to allow for reprinting of the print job from the identified sheet. Reprint system 204 may enter a logical page number or some other identifier for the logical page into page-to-sheet data structure 206. Page-to-sheet data structure 206 then return is the sheet (identified by sheet number or some other identifier) that corresponds with the logical page. Printer 106 may then restart printing at the sheet identified by reprint system 204. The operator advantageously does not need to know or guess as to the sheet to begin reprinting from as reprint system 204 is able to accurately identify the sheet for the operator.

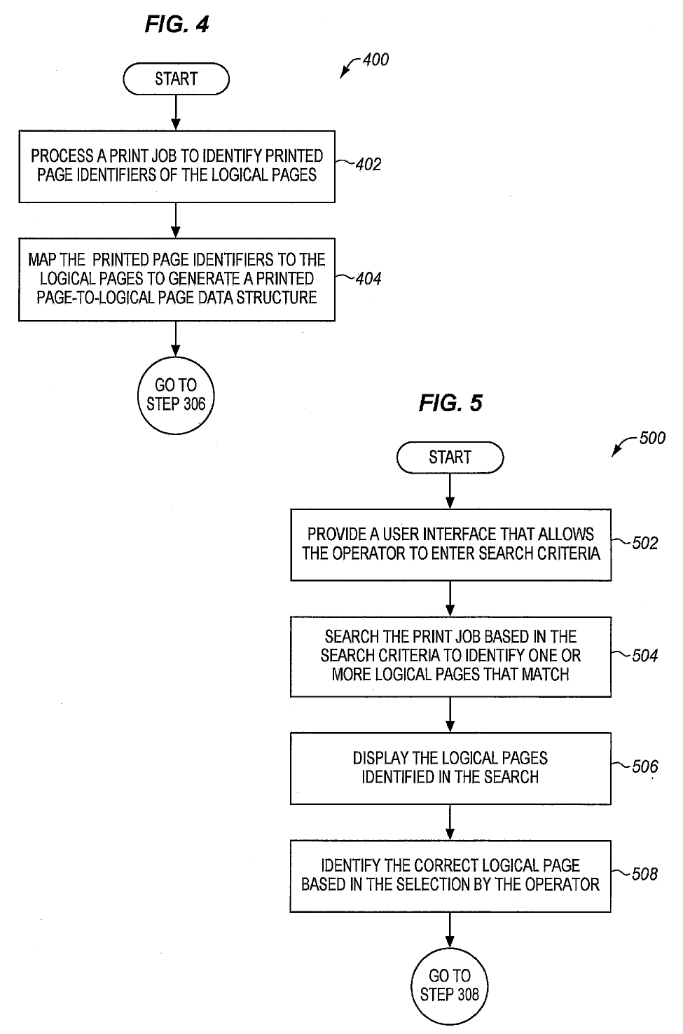

As stated above, the operator may enter a printed page identifier to indicate the restart point in one embodiment of the invention. The printed page identifier may be a number (e.g., 1, 2, 3), a letter (e.g., a, b, c, or i, ii, iii), a Roman numeral (e.g., I, II, III), or another identifier. A printed page identifier may not directly correspond with the logical page number. For instance, a printed page identifier of “vii” may correspond with logical page “7”. According to features and aspects herein, system 200 allows the operator to enter a printed page identifier as described in FIG. 4.

FIG. 4 is a flow chart illustrating a method 400 of allowing the operator to enter a printed page identifier in an exemplary embodiment of the invention. Method 400 describes some basic steps of the method, but other steps may also be performed as needed or desired. Method 400 is illustrated as being performed by system 200 provided in FIG. 2.

In step 402, mapping system 202 processes the print job to identify printed page identifiers provided in the logical pages. Printed page identifiers comprise any identifiers that indicate the sequence of the printed pages, such as printed page numbers, printed page letters, etc. Mapping system 202 may parse the content of the logical pages to identify the printed page identifiers. Based on the encoding used for the print job, the printed page identifier may be located in the same location in the logical page that is easily identifiable by mapping system 202. Mapping system 202 may also have to search for a particular character string that represents the printed page identifier in the logical page.

In step 404, mapping system 202 maps the printed page identifiers to logical pages to generate a printed page-to-logical page data structure (not shown in FIG. 2). For instance, the mapping may have printed page “i” corresponding with logical page 3, printed page “ii” corresponding with logical page 4, printed page “iii” corresponding with logical page 5, and so on.

Steps 402 and 404 may be performed simultaneously with steps 302 and 304 of FIG. 3 to generate both page-to-sheet data structure 206 and the printed page-to-logical page data structure. Page-to-sheet data structure 206 and the printed page-to-logical page data structure may comprise the same data structure.

If the operator then enters a printed page identifier that identifies the correct restart point for reprinting, then method 400 continues to step 306 of FIG. 3 where reprint system 204 identifies the logical page from which to initiate reprinting of the print job. For this embodiment, reprint system 204 receives a printed page identifier entered by the operator. Reprint system 204 identifies a logical page that corresponds with the printed page identifier entered by the operator based on the printed page-to-logical page data structure (see step 306). Reprint system 204 then identifies a sheet corresponding with the logical page based on the page-to-sheet data structure 206 (see step 308).

Also stated above, reprint system 204 may provide a search mechanism that allows the operator to search for keywords or phrases in the print job to locate the correct logical page. Assume for example that the operator detects one or more defective printed pages. The operator does not know the logical page numbers corresponding with the defective printed pages, but is able to view an account number, a phrase or other character string, or some other distinguishing text that appears on the defective printed pages. According to features and aspects herein, the system 200 allows the operator to search through the print job to locate the correct logical page based on the distinguishing text.

FIG. 5 is a flow chart illustrating a method 500 of allowing the operator to search for the correct logical page in an exemplary embodiment of the invention. Method 500 describes some basic steps of the method, but other steps may also be performed as needed or desired. Method 500 may represent a more detailed embodiment of step 306 of method 300. Method 500 is illustrated as being performed by system 200 provided in FIG. 2.

In step 502, reprint system 204 provides a user interface that allows the operator to enter search criteria. The search criteria may include a term, a keyword, a phrase, or some other character string to be searched. The search criteria may also include search limitations. For instance, the operator may specify that the search is only to include logical pages 1-100. Any desired search mechanisms are within the scope of the invention.

In step 504, reprint system 204 searches the print job based on the search criteria to identify one or more logical pages that match or substantially match the search criteria. Reprint system 204 may search the content of the logical pages based on the search criteria to identify the matching logical pages. For instance, reprint system 204 may search the content of the logical pages to find a phrase such as “Once upon a time”. Reprint system 204 may additionally or alternatively search the metadata of the logical pages to identify the matching logical pages. For instance, reprint system 204 may search the metadata to find an account number or some other distinguishing text that is not part of the content.

In step 506, reprint system 204 displays one or more logical pages identified in the search to allow for a selection by the operator. The operator may then view the logical pages or the relevant portions of the logical pages to allow the operator to determine which page is the correct logical page. The operator may then navigate to a particular logical page that matches the defective printed page, and select the logical page from which to initiate reprinting.

In step 508, reprint system 204 then identifies the logical page from which to initiate reprinting based on the selection by the operator. Method 500 continues to step 308 of FIG. 3 where reprint system 204 identifies a sheet corresponding with the logical page (as selected by the operator from the user interface) based on the page-to-sheet data structure 206. Once again, the operator advantageously does not need to know or guess as to the sheet to begin reprinting from as reprint system 204 is able to accurately identify the sheet for the operator.

Another advantage of the combination of the search mechanism and the page-to-sheet mapping can be found in the case where the print job with the error is still the active job on printer 106 (see FIG. 2). In such a case, to restart printer 106 at the correct page, printer 106 may need to know the relative offset of the restart point from the current point (e.g., go forward 150 sheets or back up 35 sheets). When the operator attempts a restart in this case, the search mechanism can display the current page from the printer's perspective and allow the operator to navigate within the print job until the correct restart point is shown. When the operator selects the target page from which to resume printing, system 200 identifies the sheet from which to initiate reprinting, and also identifies the present sheet being printed by printer 106. System 200 may then determine the necessary sheet offset to send to printer 106 based on the identified sheet for reprint and the present sheet in the printer. System 200 then provides the sheet offset to printer 106 to reposition printer 106 to the correct restart point.

Another use of system 200 of FIG. 2 is when the operator only wants to print a range of pages from a print job. Mapping system 202 can thus process the print job to identify logical pages, and map the logical pages to sheets on which the logical pages will be subsequently printed to generate page-to-sheet data structure 206 that includes only information about the selected range of pages. If a print job includes 500 pages but the operator requests that only pages 10 through 70 be printed, then mapping system 202 would generate page-to-sheet data structure 206 that includes only 60 pages of information and not all 500 pages. Alternatively, the page-to-sheet data structure would include all or substantially all for the 500 pages, but the reprint system 204 only reprints the page selection specified by the operator. The page and sheet count would be accurate because mapping system 202 would process the whole print job in order to find the correct pages to include on the sheets to be printed. An additional benefit is that mapping system 202 can automatically expand the selected range of pages to include full sheets for reprint if so desired. System 200 also allows the operator to insert blank pages in the print job so that the reprint begins on the correct page in the original place on each sheet.

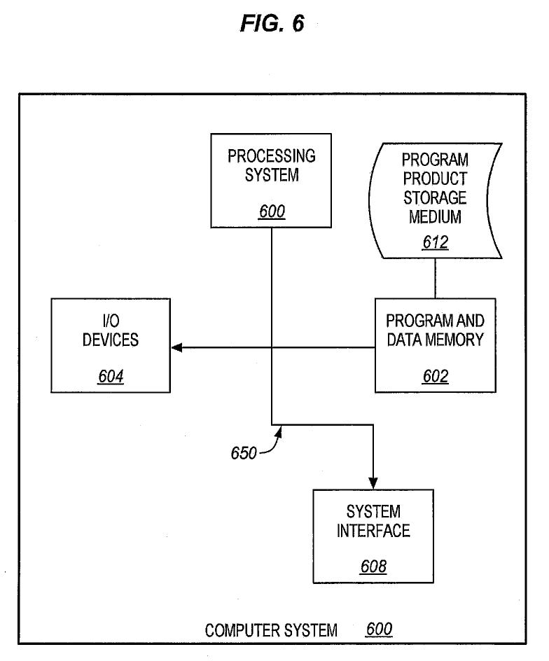

Embodiments of the invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. FIG. 6 illustrates a computer system 600 as including a data processing device adapted to provide features and aspects hereof by executing programmed instructions and accessing data stored on a computer-readable storage medium.

Furthermore, the invention can take the form of a computer program product accessible from a computer-usable or computer-readable medium 612 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processing system 600 coupled directly or indirectly to memory elements 602 through a system bus 650. The memory elements can include local memory employed during actual execution of the program code, bulk storage, and cache memories which provide temporary storage of at least some program code in order to reduce the number of times code must be retrieved from bulk storage during execution.

Input/output or I/O devices 604 (including but not limited to keyboards, displays, pointing devices, etc) can be coupled to the system either directly or through intervening I/O controllers.

Network adapters or other system interfaces 608 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

Although specific embodiments were described herein, the scope of the invention is not limited to those specific embodiments. The scope of the invention is defined by the following claims and any equivalents thereof.

We claim:

1. A method of determining the restart point for reprinting of a print job, the method comprising:
processing the print job to identify logical pages in the print job;
mapping the logical pages to sheets on which the logical pages will be subsequently printed to generate a page-to-sheet data structure;
identifying a logical page from which to initiate reprinting of the print job based on input from an operator; and
identifying a sheet corresponding with the logical page based on the page-to-sheet data structure to allow for reprinting of the print job from the identified sheet.

2. The method of claim 1 wherein processing the print job comprises:
processing the print job to identify page breaks between the logical pages in the print job; and
identifying the logical pages based on the identified page breaks.

3. The method of claim 1 wherein identifying a logical page from which to initiate reprinting of the print job based on input from an operator comprises:
receiving a range of pages to reprint from the operator as the input.

4. The method of claim 1 wherein identifying a logical page from which to initiate reprinting of the print job based on input from an operator comprises:
providing a user interface that allows the operator to enter search criteria;
searching the print job based on the search criteria to identify at least one logical page that matches the search criteria;
displaying the at least one logical page identified in the search to allow for selection by the operator; and
identifying the logical page from which to initiate reprinting of the print job based on the selection by the operator.

5. The method of claim 1 wherein mapping the logical pages to sheets:
identifying a form definition for the print job; and
mapping the logical pages to the sheets based on the form definition.

6. The method of claim 1 further comprising:
processing the print job to identify printed page identifiers provided in the logical pages of the print job; and
mapping the printed page identifiers to the logical pages to generate a printed page-to-logical page data structure;
wherein identifying a logical page from which to initiate reprinting of the print job comprises:
receiving a printed page identifier from the operator as the input; and
identifying the logical page that corresponds with the printed page identifier entered by the operator based on the printed page-to-logical page data structure.

7. A system adapted to determine the restart point for reprinting of a print job, the system comprising:
a mapping system adapted to process the print job to identify logical pages in the print job, and map the logical pages to sheets on which the logical pages will subsequently be printed to generate a page-to-sheet data structure; and
a reprint system adapted to identify a logical page from which to initiate reprinting of the print job based on input from an operator, and identify a sheet corresponding with the logical page based on the page-to-sheet data structure to allow for reprinting of the print job from the identified sheet.

8. The system of claim 7 wherein the mapping system is further adapted to:
process the print job to identify page breaks between the logical pages in the print job; and
identify the logical pages based on the identified page breaks.

9. The system of claim 7 wherein the reprint system is further adapted to:
receive a range of pages to reprint from the operator as the input.

10. The system of claim 7 wherein the reprint system is further adapted to:
provide a user interface that allows the operator to enter search criteria;
search the print job based on the search criteria to identify at least one logical page that matches the search criteria;
display the at least one logical page identified in the search to allow for selection by the operator; and
identify the logical page from which to initiate reprinting of the print job based on the selection by the operator.

11. The system of claim 7 wherein the mapping system is further adapted to:
identify a form definition for the print job; and
map the logical pages to the sheets based on the form definition.

12. The system of claim 7 wherein the reprint system is further adapted to:
process the print job to identify printed page identifiers provided in the logical pages of the print job; and
map the printed page identifiers to the logical pages to generate a printed page-to-logical page data structure;
receive a printed page identifier from the operator as the input; and
identify the logical page that corresponds with the printed page identifier entered by the operator based on the printed page-to-logical page data structure.

13. A computer program product comprising a computer useable medium including a computer readable program, wherein the computer readable program when executed on a computer causes the computer to:
process the print job to identify logical pages in a print job;
map the logical pages to sheets on which the logical pages will be subsequently printed to generate a page-to-sheet data structure;
identify a logical page from which to initiate reprinting of the print job based on input from an operator; and
identify a sheet corresponding with the logical page based on the page-to-sheet data structure to allow for reprinting of the print job from the identified sheet.

14. The computer program product of claim 13 wherein the computer readable program further causes the computer to:
process the print job to identify page breaks between the logical pages in the print job; and
identify the logical pages based on the identified page breaks.

15. The computer program product of claim 13 wherein the computer readable program further causes the computer to:
receive a range of pages to reprint from the operator as the input.

16. The computer program product of claim 13 wherein the computer readable program further causes the computer to:
provide a user interface that allows the operator to enter search criteria;
search the print job based on the search criteria to identify at least one logical page that matches the search criteria;
display the at least one logical page identified in the search to allow for selection by the operator; and
identify the logical page from which to initiate reprinting of the print job based on the selection by the operator.

17. The computer program product of claim 13 wherein the computer readable program further causes the computer to:
identify a form definition for the print job; and
map the logical pages to the sheets based on the form definition.

18. The computer program product of claim 13 wherein the computer readable program further causes the computer to:
process the print job to identify printed page identifiers provided in the logical pages of the print job;
map the printed page identifiers to the logical pages to generate a printed page-to-logical page data structure;
receive a printed page identifier from the operator as the input; and
identify the logical page that corresponds with the printed page identifier entered by the operator based on the printed page-to-logical page data structure.

19. A method of determining the restart point for reprinting of a print job, the method comprising:
identifying a form definition for printing of the print job;
processing the print job to identify page breaks in the print job;
responsive to identifying a page break for a logical page, executing a function call to map the logical page to a sheet on which the logical page will be subsequently printed based on the form definition to generate a page-to-sheet data structure;
responsive to a request to reprint a print job, the method further comprises:
identifying a logical page from which to initiate reprinting of the print job based on input from an operator; and
identifying a sheet corresponding with the logical page based on the page-to-sheet data structure to allow for reprinting of the print job from the identified sheet.

20. The method of claim 19 wherein identifying a logical page from which to initiate reprinting of the print job based on input from an operator comprises:
providing a user interface that allows the operator to enter search criteria;
searching the print job based on the search criteria to identify at least one logical page that matches the search criteria;
displaying the at least one logical page identified in the search to allow for selection by the operator; and
identifying the logical page from which to initiate reprinting of the print job based on the selection by the operator.
